(19) United States
(12) Patent Application Publication
(10) Pub. No.: US 2001/0031343 A1
(43) Pub. Date: Oct. 18, 2001

(54) Component having transfer image formed thereon and method for forming the same

(76) Inventors: Hiroshi Takabe, Minamitsuru-gun (JP); Noboru Watanabe, Minamitsuru-gun (JP); Masayo Ishida, Minamitsuru-gun (JP)

Correspondence Address: KODA & ANDROLIA, Suite 3850, 2029 Century Park East, Los Angeles, CA, 90067-3024, US

(21) Appl. No.: 09/783,629

(22) Filed: Feb. 14, 2001

(30) Foreign Application Priority Data
Feb. 21, 2000 (JP) 2000-48873
Feb. 21, 2000 (JP) 2000-48876
Nov. 22, 2000 (JP) 2000-355337
Dec. 11, 2000 (JP) 2000-375767

(51) Int. Cl. B32B 3/10; B32B 5/00; B32B 15/08; B32B 31/00; B41M 3/12; B41M 5/025

(52) U.S. Cl. 428/195; 428/209; 101/211; 101/491; 347/1

(57) ABSTRACT

A component having transfer image formed thereon using less amount of sublimable dye, capable of transferring clear color images, having sufficiently high light fastness, and yet capable of providing gold color well equivalent to that of gold plating at a low cost, said component comprising a receptor layer to which a color image is transferred from a transfer paper being superposed on the receptor layer and to which heat is applied under pressure, and said transfer paper having formed thereon the color image by printing using an ink jet printer and a sublimable dye ink. Also disclosed is a method for forming the component having transfer image formed thereon.

### BACKGROUND OF THE INVENTION

1. Field of the Invention

The present invention relates to a component having transfer image formed thereon, in which an image printed on a transfer paper is transferred by using a sublimable dye ink to a receptor layer of an object on which the image is transferred by heating while applying pressure, and to a method for forming the same.

2. Prior Art

In case of printing a color image such as a painted picture, a photographic picture, a character image, a pattern image, etc., on a transfer paper by using a sublimable dye ink heretofore, the color image was once taken into a personal computer, and was then digitized and printed on a transfer paper by using a thermal printer. The image thus printed on the transfer paper was then transferred on the surface of a receptor layer formed on the surface of a metallic plate, a glass sheet, etc., by heating while applying pressure thereto.

The method for forming the image above is disclosed, for instance, in JP-A-Hei8-282135 (the term “JP-A-” as referred herein signifies “an unexamined published Japanese patent application”). More specifically, this method for forming an image comprises providing a thermal transfer recording medium (transfer ribbon) having an ink layer containing a sublimable dye opposed to the dye image receptor layer (transfer paper) capable of receiving the sublimable dye ink, and the image is formed by transferring the ink layer of the transfer ribbon to the transfer paper by applying heat with a thermal head in accordance with the image information. The image is further transferred to the object, i.e., the component having transfer image formed thereon, by applying heat and pressure to the transfer paper on which the image is formed.

The colors of the sublimable dye inks that are used above are yellow, red (magenta), blue (cyan), and if necessary, black. Thus, a full-colored hard copy with high gradation is obtained by subsequently heating and transferring these dyes.

The method of forming a transfer image above, however, consumes too large a quantity of the sublimable dye, because the sublimable dye inks are incorporated in the transfer ribbon.

Furthermore, the component on which the color image is formed thereon in accordance with the method above suffered a problem as such that, when exposed to light in the ambient or when used under a condition of frequently changing temperature for a long duration of time, the color tone of image changes or the image becomes unclear due to the fading of the colors. This is ascribed to the fact that the sublimable dyes are easily affected by ultraviolet radiation to undergo degradation. In particular, when a sublimable dye is used in a wearable watch that is frequently used on the wrist in a state exposed to ultraviolet radiation, the sublimable dye undergoes fading and suffers poor light fastness.

On the other hand, among the components on which images are formed, the display plates of watches are often elaborately finished to exhibit a metallic gold appearance. In general, gold plating is used to finish it to provide a gold appearance.

FIG. 7 shows a cross section view of a conventional watch display plate having a gold-colored finish appearance. The watch display plate 40 comprises a metallic plate such as of brass, having a small hole 41 on the center thereof to attach the watch needles and two legs 42 on the back plane to attach the watch movements thereto. The metallic plate is aurora patterned or satin finished, and a nickel (Ni) plating layer 43, a silver (Ag) plating layer 44, and a gold (Au) plating layer 45 are sequentially formed to provide a display base 46 consisting of the thus formed multilayered plating layer. Furthermore, marks for the hour display characters 47 and the like are provided to the predetermined positions of the upper surface of the display base 46.

Thus, a watch display plate and the like having the gold color tone conventionally used in the art suffered economical disadvantage because gold is an expensive material, and because gold plating was applied to the back plane which was not perceived. This also led to a waste of material.

Furthermore, gold color can be provided in a variety of tones. In a rough classification, for instance, there are “reddish gold”, “bluish gold”, and “orange gold”. Moreover, each of the color classification is further classified into dark colors and pale colors. In the case of “reddish gold”, for instance, those having a reddish gold color tone with dense gold color are called as “red gold”, whereas those having a slightly pale gold color tone are denoted as “pale red gold”. In the case of “orange gold”, the gold color tone further paler than “pale red gold” and almost free of reddish color tone is called as “pale gold”, and a color tone still paler than “pale gold” is denoted as “pale pale gold”.

In the color classification above, the most frequently used color for the watch display plates is “pale pale gold”. Conventionally, the color tone “pale pale gold” has been achieved by applying plating using cyan gold to the base, and the color tone “pale pale gold” has been realized by controlling the applied voltage, current, the duration of plating time, etc.

Thus, it is desired to realize various types of gold color tones at a further reduced cost.

### SUMMARY OF THE INVENTION

The present invention has been made in the light of the aforementioned problems. Accordingly, an object of the present invention is to provide a component having transfer image formed thereon using less amount of sublimable dye, capable of transferring clear color images, having sufficiently high light fastness, and yet capable of providing gold color well equivalent to that of gold plating at a low cost. Another object of the present invention is to provide a method for forming the component having transfer image formed thereon.

In order to achieve the aforementioned objects, the present invention provides a component having transfer image formed thereon comprising a receptor layer to which a color image is transferred from a transfer paper being superposed on the receptor layer and to which heat is applied under pressure, said transfer paper having formed thereon the color image by printing using an ink jet printer and a sublimable dye ink.

By thus printing an image on a transfer paper using an ink jet printer and a sublimable dye ink, the amount of sublimable dye used can be reduced as compared with the case in which the transfer ribbon is used.

Further, by re-heating the color image once formed as above without applying any pressure, the printed dots are mixed to lose their original spotty appearance as to form a distinguished and clear image.

Furthermore, by transferring the color image from the transfer paper to the object to which the image is transferred with a transparent film sheet being incorporated therebetween, the dot-like spotty appearance can be eliminated without re-heating.

On the other hand, the object of the present invention above is achieved, in an aspect, by a component having transfer image formed thereon having a gold color tone comprising a base material having provided on the surface thereof a metallic film, said base material comprising a silver metallic film formed on the surface thereof, and a transparent receptor layer formed on the upper surface of the silver metallic film, said metallic film capable of yielding a controlled desired gold color tone by uniformly mixing two sublimable dye inks differing in color, i.e., a yellow-colored dye and a magenta-colored dye, being provided to the layer by infiltration.

In this manner, by osmotically providing the sublimable dyes to the receptor layer without using gold plating, a gold color tone well equivalent to that obtainable by gold plating can be realized with reduced cost.

The light fastness of the component can be further improved by providing a clear coating film containing an ultraviolet radiation absorbing agent or by using a receptor layer containing an ultraviolet radiation absorbing agent.

### BRIEF DESCRIPTION OF THE DRAWINGS

FIG. 1 is a cross section view of a display plate for watches according to an embodiment of the present invention;

FIG. 2 is an explanatory diagram related to an example of a transfer method using a film sheet;

FIG. 3 is a cross section view of a transfer film sheet having an image formed beforehand on a film sheet;

FIG. 4 is an explanatory diagram showing a method of forming a transfer film sheet shown in FIG. 3;

FIG. 5 is an explanatory diagram showing a method of transferring a color image using a transfer film sheet shown in FIG. 3;

FIG. 6 is a cross section view of a display plate for watches of another example according to the present invention; and

FIG. 7 is a cross section view of a display plate for watches of a conventional type.

### DESCRIPTION OF THE PREFERRED EMBODIMENTS

### EXAMPLES

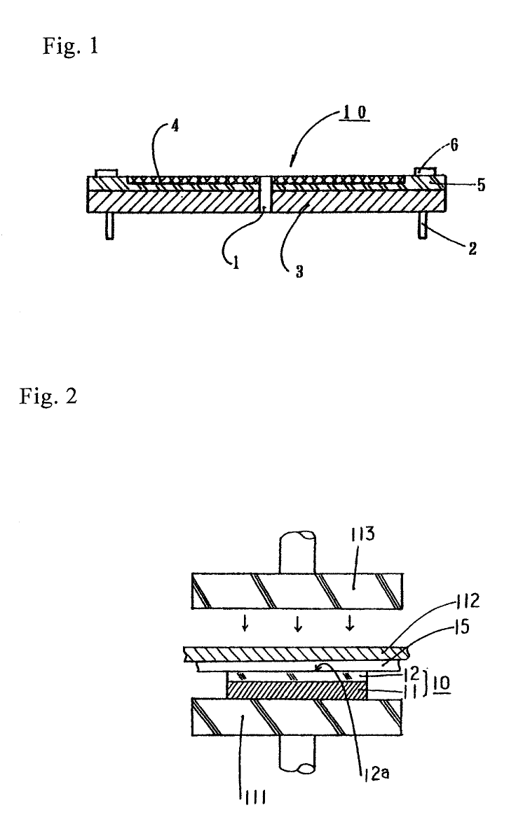

FIG. 1 is a cross section view of a display plate for watches according to an embodiment of the present invention. Referring to FIG. 1, the watch display plate 10 comprises a substrate 3 made of brass plate, having a small hole 1 on the center thereof to attach the watch needles and two legs 2 on the back plane to attach the watch movements thereto, a receptor layer 5 formed on an upper face of the substrate 3 and having formed thereon the transfer image 4 and an hour display character 6 fixed at a part of an upper place of the receptor layer 5. The substrate 3 is patterned, e.g., dimple patterned, and the surface is further provided with a plating.

The receptor layer 5 is provided at a thickness of about 20 μm, by applying a paint comprising 100 parts by weight of a transparent polyurethane resin containing dispersion blended therein 2.5 parts by weight of an ultraviolet radiation absorbing agent, i.e., 2-(3,5-di-t-butyl-2-hydroxyphenyl)benzotriazole. The surface of the receptor layer 5 is polished to provide a smooth surface.

A generally employed case of forming a color image by using an ink jet printer is explained below. The image is formed by using dyes or pigment inks of colors red (magenta), yellow, blue (cyan), and if necessary, black. The method for forming the image comprises, in case of providing an “orange color”, for instance, extremely small printing dots (spots) of “red color” and those of “yellow color” are dispersed neighboring to each other but in such a manner that they are not superposed, thereby providing an “orange color” appearance by taking advantage of the color mixing effect of “red color” and “yellow color”. Each of the printed dots is extremely small that they are hardly distinguished by the naked eye, and as the dots become finer, a higher image resolution can be achieved to result in a sharp image. Thus, in case of generating the intermediate color between “red color” and the “yellow color”, i.e., “orange color”, the printing dots of “red color” and those of “yellow color” are alternately aligned to set the printed area for each of the “red color” and “yellow color” dots equal to result in an “orange color”.

In case of obtaining a yellowish “pale orange color”, the number of printing dots for “yellow color” is increased, and the “red color” printing dots are provided at a fewer number and in a uniformly dispersed manner among the “yellow color” printing dots to result in a “pale orange color”. Hence, a “dense orange color” can be obtained by providing the printed dots in reverse. Thus, it can be understood that the colors of an image are changed by differing the number of printed dots per unit area for each of the colors.

The above explanation has been made specifically for the case of “orange color”. Similarly, “green color” can be output by mixing printing dots of “yellow color” and “blue color”. In this manner, a color image is formed by using inks of different colors, three or four colors, and by changing the arrangement or the number of printing dots.

In case of forming a color image on a transfer paper by using a sublimable dye ink according to the present invention, the inks referred in the above explanation are substituted by sublimable dye inks to print out an image such as a painted picture, a photographic picture, a character image, a pattern image, etc., on a transfer paper by using an ink jet printer. In this case, the color image is taken up into the personal computer, and is then reproduced on the display of the personal computer. The image data is digitized thereafter to form a color image by printing out the image data on a transfer paper.

The process steps for forming the receptor layer 5 are described below. The process for forming the receptor layer comprises forming a receptor layer 5 made of a transparent polyurethane resin and the like on the surface of a substrate 3, i.e., the object of the component having transfer image formed thereon. Then, after polishing the surface of the receptor layer 5, a smooth plane having luster is formed. By thus providing a smooth plane on the surface of the receptor layer 5, a clear transfer image free from color irregularities can be obtained in the transfer process step, which is described hereinafter, in case the image is transferred under the application of a uniform pressure to the entire surface.

Then, the process step for transferring a color image is described. In this process step, a transfer paper having printed thereon the color image by using the aforementioned sublimable dye inks on an ink jet printer is used. The transfer paper is then aligned and mounted on the flat receptor layer 5 formed on the surface of the substrate 3, i.e., the component having transfer image formed thereon. Thus, the color image is transferred to the receptor layer 5 by heating the receptor layer to a temperature in the vicinity of the softening point of the resin constituting the receptor layer 5 while applying a predetermined pressure. The heating and pressing conditions in the transfer process step differ depending on the resin constituting the receptor layer 5, however, the transfer can be performed by applying pressure under the conditions of, in case of using a polyurethane resin, for instance, at a temperature of ca. 180° C. and at a pressure of about 10 g/cm², for a time duration of about 40 seconds. In this manner, the vaporized dye permeates into the receptor layer 5 of the substrate 3 as to form a clear color transfer image 4 on the receptor layer 5.

In the color image thus formed, the transfer is carried out while applying pressure. This sometimes leads to an insufficient mixing of dyes provided as neighboring printed dots differing in color, thereby resulting in a transferred image pertaining the shape of dots. Furthermore, since each of the dots tends to be enlarged during the permeation, there may occur cases in which the transferred dots are visually perceived as spots. For instance, in case of providing “pale orange color” by arranging a small number of “red color” printed dots in a larger number of “yellow color” printed dots, there may be perceived transferred dot portions of “red color” as spots of “red color”, although they may not be so distinguished to naked eyes. However, this is hardly perceived in case of forming “dark orange color”. Similarly, in mixed colors of “yellow color” and “blue color”, the same phenomenon appears particularly in case of providing “pale green color”. These phenomena are specific to the case of forming color images using an ink jet printer. The phenomena cannot be overcome even if the heating temperature or the pressure force is changed.

In the embodiment according to the present invention, the phenomena above are overcome by performing re-heating. More specifically, the receptor layer 5 having transferred thereon the image is heated uniformly at the same temperature without applying pressure. In this manner, a sharp color image is formed.

The re-heating temperature in this case is set at the same temperature as that of the heating temperature during image transfer (i.e., in the vicinity of the softening point of the resin). In case of using a polyurethane resin, the temperature is set at approximately 180° C. By applying re-heating in this manner, the dyes permeated in dots into the receptor layer 5 undergo mixing, such that the spots diminish. By re-heating without applying pressure and at a predetermined temperature, the dyes undergo sufficient mixing as to provide a clear color image.

The receptor layer 5 having formed thereon a color image as described above is being formed by a paint into which an ultraviolet radiation absorbing agent is dispersion blended. Thus, a wet test using a sunshine weather meter was applied for a time duration of 100 hours to a product finished as a display plate 10 of a watch to test the corrosion resistance, light fastness, etc. As a result, it has been found that a favorable light fastness is acquired on the product, since the transferred image was found to be completely free from degradation or discoloring.

In the present example, the light fastness is acquired by forming the receptor layer 5 using a paint comprising a polyurethane resin having dispersion blended therein an ultraviolet radiation absorbing agent. Otherwise, the desired light fastness can be achieved by printing or painting, on the surface of the receptor layer 5, a clear painting containing dispersed therein an ultraviolet radiation absorbing agent. In this case, the upper plane of the clear paint may be polished to form a lustrous smooth plane, and the hour display characters may be provided thereon to obtain a display plate for watches having excellent light fastness.

In the receptor layer 5 above, a two-liquid polyurethane resin was used as the binder. However, the binder is not only limited thereto, but also usable are other resins such as a polyester resin, an epoxy resin, an acrylic resin, etc.

As the ultraviolet radiation absorbing agent, 2-(3,5-di-t-butyl-2-hydroxyphenyl)benzotriazole was used in the present invention. However, the ultraviolet radiation absorbing agent for use in the present invention is not only limited thereto, and also usable are, for instance, 2-(3-t-butyl-5-methyl-2-hydroxyphenyl)-5-chlorobenzotriazole and ultrafine particles of zinc oxide. At least one type of the ultraviolet radiation absorbing agents above is dispersion blended to the binder.

The ultrafine particles of zinc oxide described above possess excellent ultraviolet radiation absorbing function similar to that of ultrafine particles of titanium oxide, and are yet transparent. Hence, they do not affect the image color tone. Thus, the clear paint containing the ultrafine particles of zinc oxide can be applied relatively thick on the image. Furthermore, because the ultrafine particles of zinc oxide exhibit excellent antibacterial function, a favorable hygiene effect can be obtained by providing them on the outermost surface plane.

In the method for forming the layer described above, the spots generated by the dot-like permeated dyes are extinguished by re-heating. However, a transparent film sheet can be used to prevent the spots from generating. An example using such transparent film sheets is described below.

In the present example, as is shown in FIG. 2, the display plate 10 is mounted on a mounting jig 111. The display plate 10 comprises a metallic substrate 11 and a receptor layer 12 formed on the upper surface thereof. The metallic substrate 11 is made of a metallic plate of aluminum, brass, iron, etc., and surface treatment such as plating or painting, etc., is applied thereto for rust prevention or for providing an ornamental appearance. The receptor layer 12 is formed by printing or painting, etc., a paint comprising a polyurethane resin, a polyester resin, an epoxy resin, an acrylic resin, etc., having dispersed therein an ultraviolet radiation absorbing agent. The upper plane 12a of the receptor layer 12 is polished to provide a lustrous smooth plane.

As a transfer paper 112, a product similar to that described in the example above is used.

A transparent film sheet 15 is interposed between the display plate 10 and the transfer paper 112. The film sheet 15 is made of a resin such as a polypropylene resin, a polyethylene resin, polycarbonate resin, a nitrocellulose resin, a nitrofluororesin, an acrylic resin, etc., and possesses a lustrous smooth surface. The resin for forming the film sheet 15 above is not only limited to those enumerated above, and also usable are other resins selected from those having a relatively high heat resistance. However, a resin having a water-repelling function, such as the fluorine based resins, is not preferred. The thickness of the transparent film sheet 15 is limited to a range of from 25 to 50 μm.

Thus, a pressure is applied from the upper side to the film sheet 15 and the transfer paper 112 being superposed on the display plate 10 by using a pressing jig 113 while applying heating. The heating temperature and the force for applying pressure are similar to the case above, i.e., about 180° C. and approximately 10 g/cm², but the time duration of applying the pressure is preferably set longer. For instance, in case the time duration of applying the pressure is set at 90 seconds, it is preferably set slightly longer, in a range of from 100 to 110 seconds.

By applying the transfer method as above, the sublimable dye inks forming the color image on the transfer paper 112 side permeate into the film sheet 15, and further permeate into the receptor layer 12 to form the color image in the receptor layer 12. In this manner, the dyes favorably undergo mixing during transferring the image from the transfer paper 112 to the film sheet 15, and further to the receptor layer 12, to thereby prevent dot-like spots from generating in the transferred image.

In the transfer method above, the thickness of the film sheet 15 greatly affects the quality of the transferred color image. Thus, experiments were performed extensively as to find that the thickness of the film sheet 15 is preferably set in a range of from 25 to 50 μm. If the thickness should be less than 25 μm, the irregular paper pattern of the transfer paper 112 is transferred to the receptor layer 12. If the thickness should be thicker than 50 μm, on the other hand, the dyes remain inside the film sheet 15 as to result in a problematic color image lacking sharp color tone. Thus, the thickness of the film sheet 15 is set most preferably in the range described above.

By polishing the upper plane 12a of the receptor layer 12 to provide a smooth surface, the image can be transferred at a constant pressure force, thereby preventing color unevenness from generating in the transferred color tone. Furthermore, since the smoothened plane of the receptor layer 12 is brought into contact with the smooth film sheet 15, the smooth plane of the receptor layer 12 can be maintained after applying pressure as to provide a clearly finished surface.

In the present invention, a display plate 10 using a metallic plate is used as the object to which the image is transferred. However, the color image can be transferred to the surface of other components not using a metallic plate, e.g., a plastic molded component, etc.

The transfer method using a film sheet is not only limited to the case described above, in which a film sheet 15 is incorporated on transferring the color image formed on the transfer paper 112 to the receptor layer 12, but there may be employed a method comprising transferring the color image formed previously in the film sheet to the receptor layer. Thus, a transfer method using a transfer film sheet having formed previously therein a color image is described below.

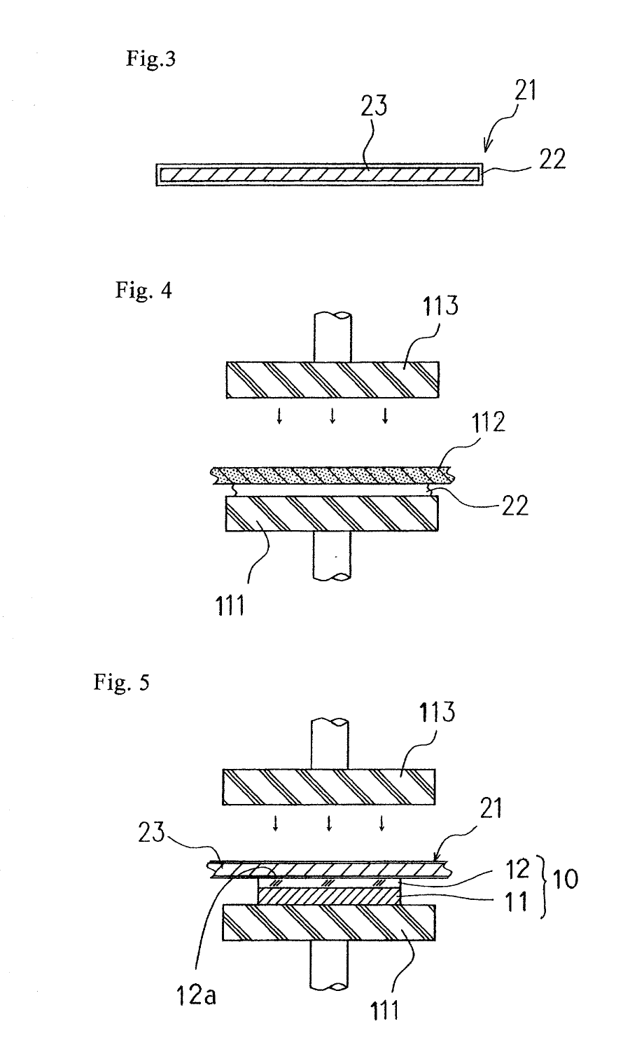

Referring to FIG. 3, a transfer film sheet 21 having formed previously therein a color image is obtained by allowing the gasified sublimable dye ink to permeate into the transparent film sheet 22 under heating and pressing. Referring to FIG. 4, the transfer film sheet 21 is formed by mounting the transparent film sheet 22 on a mounting jig 111, and after mounting thereon a transfer paper 112 having printed thereon the image with a sublimable dye ink, applying a pressure to the transfer paper 112 by using a pressurizing jig 113. The transfer of image from the transfer paper 112 to the film sheet 22 can be achieved, similar to the case described in the example above, by heating the film sheet 22 to a temperature in the vicinity of the softening point of the resin component of the film sheet 22, and by applying a constant pressure to the transfer paper 112. At this instance, the sublimable dye ink printed on the transfer paper 112 undergoes vaporization, and permeates into the film sheet 22 as to form a color image 23. The heating and pressing above are necessary to allow the sublimable dye to permeate deep into the inside of the film sheet 22; they weaken the intermolecular force of the film sheet 22 to facilitate the permeation of the vaporized sublimable dyes into the interstices of the molecules. After transfer forming the image in the manner above, a finished transfer film sheet 21 having formed thereon the color image 23 by the sublimable as shown in FIG. 3 can be obtained by lowering the temperature to the ordinary temperature. Since the intermolecular bonding of the transfer film sheet 21 then recovers the tightly bonded state at the ordinary temperature, the sublimable dye forming the color image 23 cannot be easily discharged.

The material and the thickness of the film sheet 21 are the same as those of the film sheet 15 described in the example above. Similarly, the transfer paper 112 is the same as that described in the example above.

Then, referring to FIG. 5, a method for transferring a color image to a display plate by using the transfer film sheet 21 above is described below. First, a display plate 10 is mounted on a mounting jig 111. Similar to the case described in the example above, the display plate 10 comprises a metallic substrate 11 having provided on the upper surface thereof a receptor layer 12. The upper plane 12a of the receptor layer 12 is polish finished to provide a smooth surface.

The transfer film sheet 21 is then superposed on the display plate 10, and by using a pressure jig 13, pressure is applied to the transfer film sheet 21 and the display plate 10 while heating them at a constant temperature. The transfer conditions such as the heating temperature, pressing force, etc., are set similarly as in the example above.

In accordance with the transfer method above, the vaporized sublimable dyes which formed the color image 23 in the transfer film sheet 21 permeate into the receptor layer 12, and the same image as the color image 23 formed in the transfer film sheet 21 is formed as a color image inside the receptor layer 12. At this instance, as described in the example above, the sublimable dyes undergo favorable mixing as to prevent dot-like spots from generating.

Thus, by preparing transfer film sheets 21 having formed previously thereon the color image, the necessary color images can be readily transferred to the object when necessary. In particular, unlike the transfer paper 112 which gradually loses the sublimable dye ink with the passage of time by vaporization, the transfer film sheet 21 can be stored as stocks for a long duration of time. Furthermore, by mixing an ultraviolet radiation absorbing agent and the like into the film sheet 22, the degradation of the sublimable dye ink ascribed to ultraviolet radiation can be prevented from occurring.

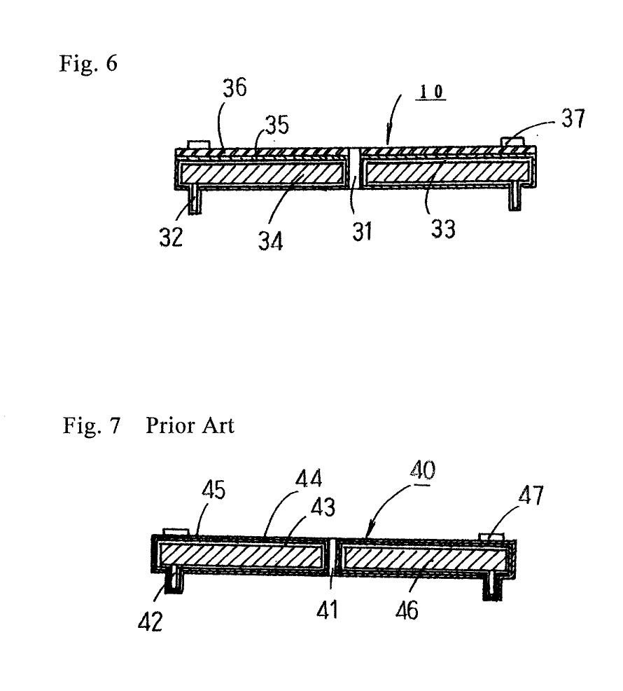

FIG. 6 shows a cross section view of a display plate for watches, and particularly in the present invention, it shows a constitution for obtaining a gold color tone denoted as “pale pale gold”. Referring to FIG. 6, the watch display plate 10 comprises a metallic plate made of brass and the like, having a small hole 31 on the center thereof to attach the watch needles and two legs 32 on the back plane to attach the watch movements thereto. The metallic plate is patterned, e.g., aurora patterned, and the base plate 34 is further provided with a nickel (Ni) plating 33, a silver (Ag) plating, and a silver metallic film 35 thereon.

The receptor layer 36 is made of a transparent polyurethane resin and the like, and is formed on the upper plane of the silver metallic film 35 by means of printing and the like. In this receptor layer 36 again, an ultraviolet radiation absorbing agent similar to that described in the aforementioned receptor layer 5 is dispersion blended. The surface of the receptor layer 36 is polished to provide a smooth surface. Furthermore, metallic hour display characters 37 are fixed at the predetermined positions of the upper plane of the receptor layer 36. Similar to the example described above, sublimable dyes are allowed to permeate in the receptor layer 36 by the transfer method above, and the “pale pale gold” finish is obtained in the following manner.

More specifically, printing using the sublimable dye inks is performed on the transfer paper by using an ink jet printer. The printing is provided on a white colored transfer paper by printing the image with two colors, i.e., “red color” and “yellow color” sublimable dye inks in dots each about 1440 dpi in size. In this case, it is set as such that the “yellow color” dots account for a printing area of about 8%, the “red color” dots account for a printing area of about 2%, and the rest of the white colored area accounts for about 90%, provided that the “yellow color” and “red color” dots are uniformly dispersed, such that they may not be superposed on each other.

Then, the transfer paper is mounted on the smooth plane of the receptor layer 36, and heating under pressure is performed for a time duration of about 40 seconds at a heating temperature of ca. 180° C. and under a pressure of 10 g/cm². In this manner, the sublimable dye of the transfer paper undergoes vaporization to permeate into the receptor layer 36, thereby providing a desired gold color tone transferred to the receptor layer 36.

In this case again, in order to sufficiently effect mixing of the dyes permeated into the receptor layer 36, heating is carried out again without applying pressure. The heating temperature is set to about 180° C., and the heating is continued for a time duration of about 30 seconds to 30 minutes to uniformly heat the entire structure. The heating can be performed by, for instance, mounting the display plate on a flat hot plate, or by irradiating a far infrared radiation to the display plate being mounted on a flat net-like mounting table. By performing the re-heating, the dyes which have permeated into the form of dots undergo mixing as to extinguish the spots, thereby resulting in an extremely clear “pale pale gold” gold color tone.

Then, the setting for obtaining a “pale gold” color tone is described below. In this case again, printing on a transfer paper using the sublimable dye inks in dots each about 1440 dpi in size is performed by using an ink jet printer. The printing is provided on a white colored transfer paper by printing the image, while setting as such that the “yellow color” dots account for a printing area of about 30%, that the “red color” dots account for a printing area of about 5%, and that the rest of the white colored area accounts for about 65%, provided that the “yellow color” and “red color” dots are uniformly dispersed, such that they may not be superposed on each other. Then, similar to the case of realizing the color tone above, the image is transferred from the transfer paper to the receptor layer by heating under pressure, and the spots of printed dots are eliminated by uniformly re-heating the entire product. Thus, a clear “pale gold” gold color tone is obtained.

The setting for obtaining a “pale red gold” color tone is described below. In this case again, printing on a transfer paper using the sublimable dye inks in dots each about 1440 dpi in size is performed by using an ink jet printer. The printing is provided on a white colored transfer paper by printing the image, under settings as such that the “yellow color” dots account for a printing area of about 39%, that the “red color” dots account for a printing area of about 7%, and that the rest of the white colored area accounts for about 54%, provided that the “yellow color” and “red color” dots are uniformly dispersed, such that they may not be superposed on each other. Then, similar to the case of realizing the color tone above, the image is transferred from the transfer paper to the receptor layer by heating under pressure, and the spots of printed dots are eliminated by uniformly re-heating the entire product. Thus, a clear “pale red gold” gold color tone is obtained.

The setting for obtaining a “red gold” color tone is described below. In this case again, printing on a transfer paper using the sublimable dye inks in dots each about 1440 dpi in size is performed by using an ink jet printer. The printing is provided on a white colored transfer paper by printing the image, under settings as such that the “yellow color” dots account for a printing area of about 49%, that the “red color” dots account for a printing area of about 12%, and that the rest of the white colored area account for about 39%, provided that the “yellow color” and “red color” dots are uniformly dispersed, such that they may not be superposed on each other. Then, similar to the case of realizing the color tone above, the image is transferred from the transfer paper to the receptor layer by heating under pressure, and the spots of printed dots are eliminated by uniformly re-heating the entire product. Thus, a clear “red gold” gold color tone is obtained.

As described above, to control the color tone to “pale pale gold”, “pale gold”, “pale red gold”, and “red gold”, the total area of the printed “yellow color” dots and the total area of the printed “red color” dots are set at a ratio of about 4 to 6 of the former to 1 of the latter (4-6:1), provided that the sum of the total area of the printed “yellow color” dots and the total area of the printed “red color” dots account for about 10 to 61% per unit area of the transfer paper. Although the gold color changes reddish from “pale pale gold” to “red gold”, the mixing ratio of “red color” does not increase, but the color tends to get reddish by increasing the total area of the “yellow color” and the “red color” dyes permeated into the transfer paper. The setting from “pale pale gold” to “red gold” can be controlled, not by the mixing ratio of the colors, but by the amount of dye permeated.

In the transfer paper according to the present example, a mixed color is implemented by using two colors, i.e., “yellow color” and “red color” sublimable dye inks, by uniformly dispersing respective color dots, such that they may not be superposed on each other and by printing the uniformly dispersed color dots. Thus, a mixed color is realized by the mixing of the dots during transferring and re-heating. The same can be realized, for instance, by using an “orange color” sublimable dye ink obtained by mixing the two colors, i.e., “yellow color” and “red color” sublimable dye inks, in a predetermined ratio, and by performing dot printing on a white colored transfer paper by an ink jet printer.

Concerning the heating under pressure for transferring the image to the receptor layer and the re-heating for the homogenization of the dots, a similar process as described in the examples above can be employed.

Furthermore, in the present example, the material of the receptor layer 36 and the formation of the ultraviolet radiation absorbing agent and the clear paint are the same as those described in the examples above.

The present invention has been described above by specifically making reference to a display plate of a watch, but the present invention is not only limited thereto, and can be applied to instruments or communication equipment having display units, or to office automation machines, etc. It can also be applied simply to various types of name plates, various types of sealing plates, etc.

On the other hand, in the re-heating process step of the example above, the heating is carried out in such a manner that the dyes undergo circulation inside the receptor layer to sufficiently mix the dyes provided in dots within a short time duration. Thus, the heating temperature is set at a temperature as high as about 180° C. (for about 30 seconds to 3 minutes), or, in some cases, at an extremely high temperature of 200° C. to 270° C. (for about 5 to 15 minutes). Occasionally, there may happen a case in which the vaporized dye escapes from the receptor layer due to the heating performed at such a high temperature. Furthermore, color unevenness may sometimes occur due to the dye which penetrates into the transparent protective film layer, such as the clear paint, etc., that is formed on the upper side of the receptor layer. Such cases may be coped with by hardening the receptor layer after the re-heating. More specifically, the hardening of the receptor layer is performed at a low temperature at which the dyes do not undergo circulation; for instance, at a temperature of 100° C., for a long duration of time; e.g., the heating is continued for about 30 minutes. In this manner, the discharge of dyes from the receptor layer as well as the penetration of the dyes into the transparent protective film layer can be prevented from occurring after re-heating. Further, the receptor layer contains a hardening agent such as polyisocyanate, and is preferably forcibly hardened in a short period of time by applying heating.

In accordance with the present invention as described above, a color image is printed and formed on a transfer paper by using an ink jet printer and a sublimable dye, and the color image thus formed is transferred to the receptor layer by applying heating under pressure to form the image. Thus, an image can be formed by using a sublimable dye ink, and without using a transfer ribbon. In this manner, the amount of usage of the sublimable dyes can be decreased as to reduce the cost.

Further according to the present invention, the image transferred to the receptor layer is re-heated without applying pressure. Thus, the dyes formed in dots undergo sufficient mixing, thereby resulting in the formation of a sharp and clear color image.

Since an ultraviolet radiation absorbing agent is dispersed in the receptor layer or in the clear painting formed thereon, color fading or discoloration attributed to ultraviolet radiation can be prevented from occurring, thereby providing a component having formed thereon a transfer image having excellent light fastness.

Further, by transferring a color image by interposing a film sheet between the transfer paper and the receptor layer, the generation of dot-like spots can be prevented from generating, yet without applying re-heating.

By forming a transfer film sheet beforehand by allowing a color image to permeate into a film sheet, the color image can be stored in a transferable state, thereby resulting in an increased production efficiency and in a reduction of cost.

In the case of acquiring gold color, a gold color tone well comparable to that achievable by gold plating, can be implemented, yet without using expensive gold. Thus, the cost can be considerably reduced.

From the invention thus described, it will be obvious that the invention may be varied in many ways. Such variations are not to be regarded as a departure from the spirit and scope of the invention, and all such modifications as would be obvious to one skilled in the art are intended for inclusion within the scope of the following claims.

1. A component having a transfer image formed thereon, comprising a receptor layer to which a color image is transferred from a transfer paper being superposed on the receptor layer and to which heat is applied under pressure, said transfer paper having formed thereon the color image by printing using an ink jet printer and a sublimable dye ink.

2. A component having a transfer image formed thereon, comprising a receptor layer to which a color image is transferred from a transfer paper being superposed on the receptor layer and to which heat is applied under pressure, and the color image thus formed by transferring being re-heated without applying pressure to thereby mix the neighboring transferred dots to provide a uniform color tone, said transfer paper having formed thereon the color image by printing using an ink jet printer and a sublimable dye ink.

3. A method for forming a component having a transfer image formed thereon, comprising:
a step of forming a color image on a transfer paper by printing the color image by using a sublimable dye ink and an ink jet printer;
a step of forming a receptor layer made of a transparent polyurethane resin and the like on the surface of the component for forming thereon the image;
a step of forming a flat polished plane by polishing the surface of said receptor layer;
a step of superposing, on said surface-polished receptor layer, said transfer paper having formed thereon the color image by printing; and
a step of transferring the color image on said transfer paper to the receptor layer of said component having transfer image formed thereon by applying heat under pressure.

4. A method for forming a component having a transfer image formed thereon, comprising:
a step of forming a color image on a transfer paper by printing the color image by using a sublimable dye ink and an ink jet printer;
a step of forming a receptor layer made of a transparent polyurethane resin and the like on the surface of the component for forming thereon the image;
a step of forming a flat polished plane by polishing the surface of said receptor layer;
a step of superposing, on said surface-polished receptor layer, said transfer paper having formed thereon the color image by printing;
a step of transferring the color image on said transfer paper to the receptor layer of said component having transfer image formed thereon by applying heat under pressure; and
a step of forming a color image having a uniform color tone by re-heating the transferred color image without applying pressure, thereby mixing the neighboring transferred dots.

5. In a method for transferring a color image being formed on a transfer paper with a sublimable dye ink to the component for forming transferred image by heating under pressure,
the method for forming a component having transfer image formed thereon comprises interposing a transparent film sheet between said transfer paper and the receptor layer formed on said component having transfer image formed thereon, and transferring the color image formed on said transfer paper to said receptor layer through the film sheet.

6. A method for forming a component having transfer image formed thereon as claimed in claim 5, wherein said film sheet has a thickness of 25 to 50 μm.

7. A method for forming a component having transfer image formed thereon as claimed in claim 5 or 6, wherein said film sheet is made of 1 or 2 or more of resins selected from a group consisting of a polypropylene resin, a polyethylene resin, polycarbonate resin, a nitrocellulose resin, a nitrofluororesin, and an acrylic resin.

8. A method for forming a component having transfer image formed thereon as claimed in claim 5, wherein the surface of said receptor layer is polished to form a smooth plane.

9. A transfer film sheet that is formed by transferring a color image formed on a transfer paper by using a sublimable dye ink to a transparent film sheet by heating under pressure.

10. A transfer film sheet as claimed in claim 9, wherein said film sheet has a thickness of 25 to 50 μm.

11. A transfer film sheet as claimed in claim 9 or 10, wherein said film sheet is made of 1 or 2 or more of resins selected from a group consisting of a polypropylene resin, a polyethylene resin, polycarbonate resin, a nitrocellulose resin, a nitrofluororesin, and an acrylic resin.

12. In a method for transferring a color image being formed on a transfer paper with a sublimable dye ink to the component for forming transferred image by heating under pressure,
the method for forming a component having transfer image formed thereon comprises mounting a transfer film sheet formed by transferring the color image being formed on the transfer paper to a transparent film by applying heat under pressure on the receptor layer formed on said component having transfer image formed thereon, and transferring the color image to said receptor layer by applying heat to said transfer film sheet under pressure.

13. A method for forming a component having transfer image formed thereon as claimed in claim 12, wherein the surface of said receptor layer is polished to form a smooth plane.

14. In a component having transfer image formed thereon comprising a base material formed thereon a metallic film to yield a gold color tone, the component having transfer image formed thereon comprises:
a silver metallic film formed on said base material; and a receptor layer formed on the upper plane of the silver metallic film, yielding a gold color tone of a desired color by allowing sublimable dye inks of two colors, i.e., yellow color and red color sublimable dye inks, to be infiltrated at a predetermined ratio.

15. In a component having transfer image formed thereon comprising a base material formed thereon a metallic film to yield a gold color tone, the component having transfer image formed thereon comprises:
a silver metallic film formed on said base material; and
a receptor layer formed on the upper plane of the silver metallic film, in which yellow color and red color sublimable dye inks provided at a predetermined ratio are transferred from a transfer paper having printed uniformly thereon the sublimable dye inks of two colors, i.e., yellow color and red color sublimable dye inks, by using an ink jet printer by applying heating under pressure, said receptor layer yielding a gold color tone as desired by mixing said yellow color and red color dyes.

16. In a component having transfer image formed thereon comprising a base material formed thereon a metallic film to yield a gold color tone, the component having transfer image formed thereon comprises:
a silver metallic film formed on said base material; and
a receptor layer formed on the upper plane of the silver metallic film, in which yellow color and red color sublimable dye inks are transferred from a transfer paper having printed uniformly thereon the sublimable dye inks of two colors, i.e., yellow color and red color sublimable dye inks, at a predetermined ratio, by using an ink jet printer by applying heating under pressure, and by applying re-heating thereafter without applying pressure to mix said yellow color and red color dyes, said receptor layer yielding a gold color tone as desired by mixing said yellow color and red color dyes.

17. In a component having transfer image formed thereon comprising a base material formed thereon a metallic film to yield a gold color tone, the component having transfer image formed thereon comprises:
a silver metallic film formed on said base material; and
a receptor layer formed on the upper plane of the silver metallic film, said receptor layer obtained, by first printing yellow color dots and uniformly dispersed red color dots without being superposed on the yellow dots on a transfer paper using yellow color and red color sublimable dye inks and an ink jet printer, set in such a manner that the ratio of the total area of the yellow color dots to the total area of the red color dots roughly falls in a range of 4:1 to 6:1, and that the sum of the total area of the yellow color dots and that of the red color dots account for about 10 to 61% per unit area, and by then transferring the dots to the receptor layer by superposing the transfer paper and applying heating under pressure, thereby yielding a gold color tone as desired by mixing the neighboring dots.

18. In a component having transfer image formed thereon comprising a base material formed thereon a metallic film to yield a gold color tone, the component having transfer image formed thereon comprises:
a silver metallic film formed on said base material; and
a receptor layer formed on the upper plane of the silver metallic film, said receptor layer obtained, by first printing yellow color dots and uniformly dispersed red color dots without being superposed on the yellow dots on a transfer paper using yellow color and red color sublimable dye inks and an ink jet printer, set in such a manner that the ratio of the total area of the yellow color dots to the total area of the red color dots roughly falls in a range of 4:1 to 6:1, and that the sum of the total area of the yellow color dots and that of the red color dots account for about 10 to 61% per unit area; by then transferring the dots to the receptor layer by superposing the transfer paper and applying heating under pressure; and by applying re-heating without applying pressure thereto; thereby yielding a gold color tone as desired by mixing the neighboring dots.

19. In a component having transfer image formed thereon comprising a base material formed thereon a metallic film to yield a gold color tone, the component having transfer image formed thereon comprises:
a silver metallic film formed on said base material; and
a receptor layer formed on the upper plane of the silver metallic film and yielding a gold color tone as desired, said receptor layer obtained by infiltrating an orange color sublimable ink obtained by mixing yellow color and red color sublimable dye inks at a predetermined ratio.

20. In a component having transfer image formed thereon comprising a base material formed thereon a metallic film to yield a gold color tone, the component having transfer image formed thereon comprises:
a silver metallic film formed on said base material; and
a receptor layer formed on the upper plane of the silver metallic film, said receptor layer obtained by first superposing a transfer paper having printed thereon dots of an orange color sublimable ink obtained by mixing yellow color and red color sublimable dye inks at a predetermined ratio and by using an ink jet printer; and by then transferring the dots of the transfer paper to the receptor layer by applying heating under pressure, thereby yielding a gold color tone as desired by mixing the neighboring dots.

21. In a component having transfer image formed thereon comprising a base material formed thereon a metallic film to yield a gold color tone, the component having transfer image formed thereon comprises:
a silver metallic film formed on said base material; and
a receptor layer formed on the upper plane of the silver metallic film, said receptor layer obtained by first superposing a transfer paper having printed thereon dots of an orange color sublimable ink obtained by mixing yellow color and red color sublimable dye inks at a predetermined ratio and by using an ink jet printer; by then transferring the dots of the transfer paper to the receptor layer by applying heating under pressure; and applying re-heating thereto to mix the neighboring dots; thereby yielding a gold color tone as desired.

22. In a component having transfer image formed thereon comprising a base material formed thereon a metallic film to yield a gold color tone, the component having transfer image formed thereon comprises:
a silver metallic film formed on said base material; and a receptor layer formed on the upper plane of the silver metallic film, said receptor layer formed by mixing into a transparent binder such as polyurethane resin, at least one type of an ultraviolet radiation absorbing agent selected from
2-(3,5-di-t-butyl-2-hydroxyphenyl)benzotriazole, 2-(3-t-butyl-5-methyl-2-hydroxyphenyl)-5-chlorobenzotriazole, or superfine particles of zinc oxide, and said receptor layer yielding a gold color tone of a desired color by allowing sublimable dye inks of two colors, i.e., yellow color and red color sublimable dye inks, to be infiltrated at a predetermined ratio.
